(19) United States
(12) Patent Application Publication
(10) Pub. No.: US 2015/0101890 A1
(43) Pub. Date: Apr. 16, 2015

(54) Encoder Eccentricity Correction For Elevator Systems

(71) Applicant: Otis Elevator Company, Farmington, CT (US)

(72) Inventors: Slade R. Culp, Coventry, CT (US); Keunmo Kang, South Windsor, CT (US); Sameh Dardona, South Windsor, CT (US); William A. Veronesi, Hartford, CT (US)

(21) Appl. No.: 14/397,021

(22) PCT Filed: Jun. 4, 2012
(86) PCT No.: PCT/US12/40695

§ 371 Date: Oct. 24, 2014

(51) Int. Cl. B66B 1/34; H02K 11/00; H02P 29/00; G01D 5/32

(52) U.S. Cl. CPC B66B 1/3492; G01D 5/32; H02K 11/0026; H02P 29/00
USPC 187/305; 250/231.13; 310/68 B; 318/490

(57) ABSTRACT

An encoder assembly is disclosed. The encoder assembly comprises a motor having a rotor, and an encoder. The encoder comprises an encoder wheel axially coupled to the rotor, a first sensor configured to detect a first velocity at which a portion of the encoder wheel moves relative to the first sensor, and a second sensor configured to detect a second velocity at which a portion of the encoder wheel moves relative to the second sensor, the first sensor and the second sensor positioned approximately 180 degrees apart from each other about an axis of rotation of the rotor.

### CROSS-REFERENCE TO RELATED APPLICATION

This Application is a US National Stage under 35 USC §371 of International Patent Application No. PCT/US12/40695 filed on Jun. 4, 2012.

### FIELD OF THE DISCLOSURE

The present disclosure relates generally to elevator systems and, more particularly, to systems and methods utilizing encoders.

### BACKGROUND OF THE DISCLOSURE

Ensuring ride quality in elevator systems typically involves accurate detection of the angular position and velocity of the drive motors used in these systems. Feedback systems for elevators are typically used to track the position or velocity of elevator cars as they are moved along elevator hoistways. More specifically, elevators typically employ encoders that are configured to monitor the rotational displacement, angular position, and/or velocity of the drive motors that drive the elevator cars. Using known mechanical relationships between a particular motor, the associated fraction sheaves and tension members, and a hoistway, data provided by an encoder can be used to determine the position and/or velocity of the elevator car within the hoistway.

However, eccentricity in the rotational motion of the motor's rotor can introduce non-linear errors into the encoder signal, which may result in decreased ride quality and performance. Typically, this problem is solved by isolating the encoder from the eccentric motion. This isolation can be accomplished by using hollow shaft encoders with integrated bearings and flexible mountings. However, this approach increases the cost of the associated angular position and velocity measurement systems.

Thus, there exists a need for a simplified, reliable, and inexpensive system and method to correct for encoder eccentricity in elevator systems.

### SUMMARY OF THE DISCLOSURE

An exemplary embodiment of the present invention is directed to an encoder assembly. The exemplary encoder assembly may comprise a motor having a rotor, and an encoder. The encoder may comprise an encoder wheel axially coupled to the rotor, a first sensor configured to detect a first velocity at which a portion of the encoder wheel moves relative to the first sensor, and a second sensor configured to detect a second velocity at which a portion of the encoder wheel moves relative to the second sensor. The first and the second sensor may be positioned approximately 180 degrees apart from each other about an axis of rotation of the rotor.

According to another embodiment, a method of correcting for eccentricity of an encoder in an elevator system is disclosed. The method may comprise using a first sensor to detect a first velocity at which a portion of an encoder wheel moves relative to the first sensor, the encoder wheel being axially coupled to a motor rotor of an elevator system. The method may further comprise using a second sensor to simultaneously detect a second velocity at which a portion of the encoder wheel moves relative to the second sensor, the second sensor positioned approximately 180 encoder wheel degrees apart from the first sensor. The method may further comprise averaging the first velocity and the second velocity to determine a corrected rotational velocity of the motor rotor.

According to yet another embodiment, a system is disclosed. The system may comprise a motor comprising a rotor, and an encoder to determine a rotational speed of the rotor. The encoder may comprise an encoder wheel axially coupled to the rotor, a plurality of sensors fixed at predetermined positions relative to the encoder wheel, each of the plurality of sensors configured to determine a speed at which the encoder wheel passes by the sensor, and a processor to receive inputs from the plurality of sensors related to the determined speeds. The processor may be configured to determine an actual speed of rotation of the motor based on the received inputs.

These and other aspects and features of the invention will become more readily apparent upon reading the following detailed description when taken in conjunction with the accompanying drawings.

Although various features are disclosed in relation to specific exemplary embodiments of the invention, it is understood that the various features may be combined with each other, or used alone, with any of the various exemplary embodiments of the invention without departing from the scope of the invention. For example, the encoder wheel may include a code wheel pattern on a circumferential track. The first and second sensors may be configured to detect the code wheel pattern on the circumferential track of the encoder wheel. Additionally, the motor may have a stator with the first and second sensors operatively mounted to the stator and disposed about the circumferential track of the encoder wheel. In another example, the encoder may comprise a reflective optical encoder mounted to the motor. The encoder assembly may also be configured to determine an angular velocity of the motor based on the first and second velocities at a point in time. The encoder assembly may further comprise a processor, operatively connected to the first and second sensors, the processor configured to determine a rotational speed of the rotor based on inputs from the first sensor and the second sensor. The processor may be part of a drive system. The drive system may determine a corrected velocity of the motor by averaging the first velocity and the second velocity. The encoder system may be a component of an elevator system.

In another example, a drive system may be used to determine the first and second velocities based on the input of the first and second sensors, the drive system comprising at least one of a processor, processing circuit, controller, control unit, or other electrical component. The encoder wheel, first sensor, and second sensor may comprise a reflective optical encoder.

In yet another example, the plurality of sensors may consist of two sensors, and the predetermined positions relative to the encoder are approximately one hundred and eighty degrees apart relative to an axis of rotation of the rotor. The processor may be configured to determine the actual speed of rotation of the motor by averaging the determined speeds. The processor may be configured to determine the actual speed of rotation of the motor by averaging the determined speeds according to a weighted average determined by the relative predetermined positions of the plurality of sensors.

### BRIEF DESCRIPTION OF THE DRAWINGS

FIG. 1 is a partial perspective view of a conventional (prior art) elevator according to an exemplary embodiment of the present invention;

FIG. 2 is a partial perspective view of the (prior art) motor of the elevator of FIG. 1;

FIG. 3 is a front view of the (prior art) encoder wheel of FIG. 2;

FIG. 4A is a front view of the encoder assembly of FIG. 2 at a particular instant in time;

FIG. 4B is an enlarged view of the first sensor and code wheel pattern of FIG. 4A;

FIG. 4C is an enlarged view of the second sensor and code wheel pattern of FIG. 4A;

FIG. 5A is a front view of the encoder assembly of FIG. 2 at another instant in time;

FIG. 5B is an enlarged view of the first sensor and code wheel pattern of FIG. 5A;

FIG. 5C is an enlarged view of the second sensor and code wheel pattern of FIG. 5A;

FIG. 6 is a graphical view of waveforms of motor velocity error generated by the configuration of the first and second sensors of FIG. 4A; and

FIG. 7 is a flowchart outlining a method of correcting for encoder eccentricity in an elevator system according to an exemplary embodiment of the present invention.

While the present disclosure is susceptible to various modifications and alternative constructions, certain illustrative embodiments thereof will be shown and described below in detail. The invention is not limited to the specific embodiments disclosed, but instead includes all modifications, alternative constructions, and equivalents thereof.

### DETAILED DESCRIPTION

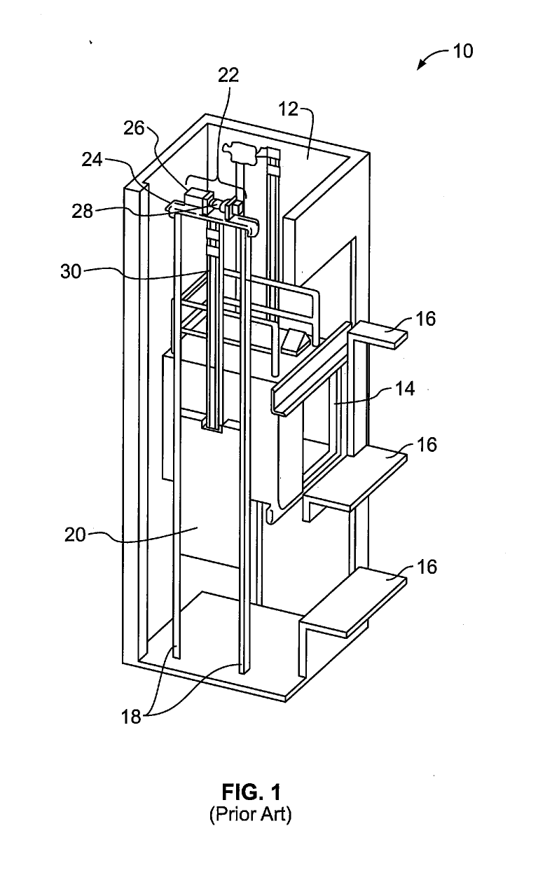

FIG. 1 is a schematic diagram of an exemplary elevator system 10. This elevator system 10 is shown for illustrative purposes to assist in disclosing features of various embodiments of the invention. As is understood by a person skilled in the art, FIG. 1 does not depict all of the components of an exemplary elevator system, nor are the depicted features necessarily included in all elevator systems.

As shown in FIG. 1, an elevator system 10 is located wholly or partially in a hoistway 12 that is vertically disposed within a building. The hoistway 12 provides a vertical path through which an elevator car 14 travels between floors or landings 16 of the building. A plurality of rails 18 extend substantially the length of the hoistway 12. The elevator car 14 and counterweight 20 are slidably mounted to various ones of the rails 18 such that the elevator car 14 and the counterweight 20 are guided by the rails 18 when moving in the hoistway 12. While not depicted in detail, both the elevator car 14 and the counterweight 20 may further include rollers, slide guides, or the like, to slidably engage the rails 18 in a secure fashion so as to provide for smooth motion of the car 14 and/or counterweight 20 along the rails 18.

A machine 22 is used to move the elevator car 14 between landings 16. As shown, the machine 22 may be supported by a bedplate 24 that is located within an upper portion of the hoistway 12 or in a separate machine room. The machine 22 may include a motor 26, or other prime mover, and a traction sheave 28 coupled thereto. Tension members 30, such as belts, ropes, cables, and the like, connect the elevator car 14 and the counterweights 20. The tension members 30 maintain frictional contact with the traction sheave 28. As the motor 26 rotates the traction sheave 28, the tension members 30 also rotate to lift or lower the elevator car 14 to a desired floor or landing 16.

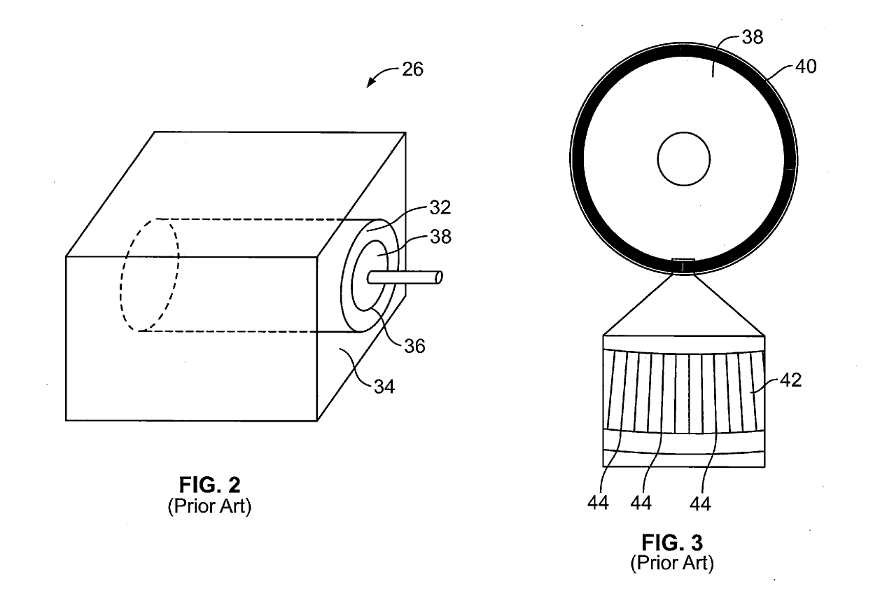

Turning now to FIG. 2, a motor 26 of the machine 22 is configured to drive the elevator car 14 through the hoistway. The exemplary motor 26 includes a rotor 32 and a stator 34. Although the elevator motor 26 shown in FIG. 2 depicts the rotor 32 inside the stator 34, with the rotor having a smaller diameter than the stator 34, the system and method of correcting for encoder eccentricity described herein are not restricted to use with such a motor. For example, the system and method of correcting for encoder eccentricity described herein can also be used in conjunction with an elevator motor having a stator inside a rotor with a larger diameter than the stator. As depicted in FIG. 2, an encoder 36 configured to determine the rotational angular position of the motor rotor 32 may be coupled to the motor 26. The type of encoder is not critical to the invention; example encoder types include, but are not limited to, optical encoders, transmissive encoders, and reflective optical encoders.

The encoder 36 may comprise an encoder wheel 38 axially coupled to the rotor 32. As depicted in FIG. 3, the exemplary encoder wheel 38 includes a circumferential track 40 on which a plurality of equally spaced reflective strips 44 form a code wheel pattern 42.

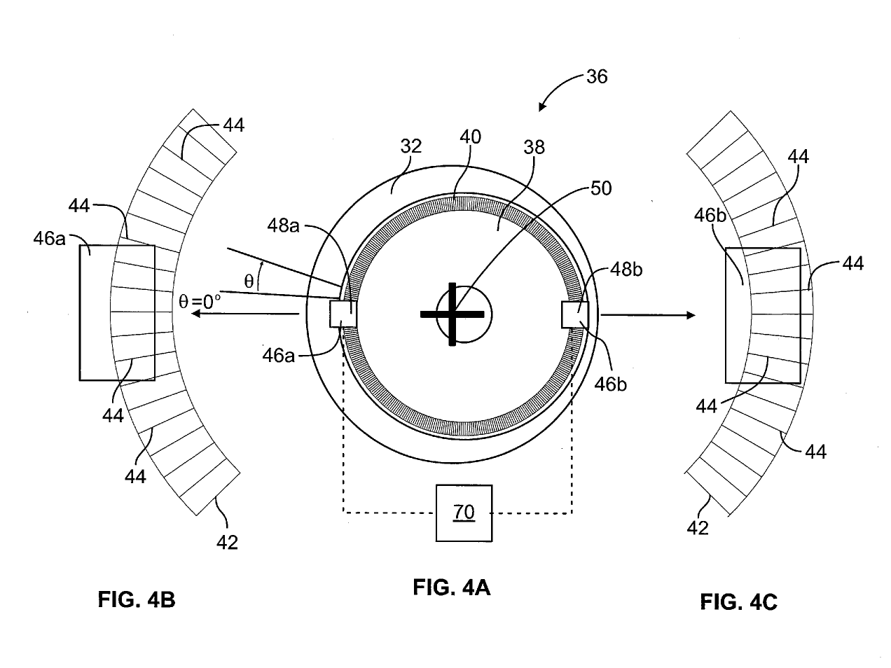

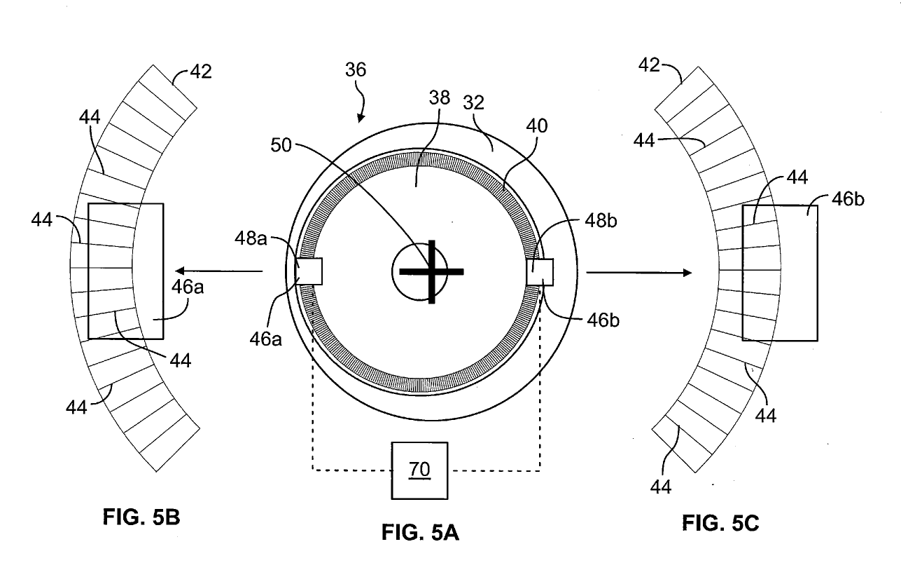

As further depicted in FIGS. 4A-4C and according to an exemplary embodiment of the invention, an exemplary encoder 36 may have at least two detectors or sensors 46a, 46b mounted to the stator 34 of the motor 26. The detectors may be disposed about the circumferential track 40 of the encoder wheel 38, as shown best in FIGS. 4A through 5C. Sensors 46a, 46b are configured to detect the code wheel pattern 42 on the circumferential track 40 of the encoder wheel 38. According to various embodiments of the invention, sensors 46a, 46b may include light emitters 48a, 48b, respectively. The light emitters 48a, 48b may emit light pulses which reflect off of reflective strips 44 that form the code wheel pattern 42. Each sensor 46a and 46b may then detect the reflected light pulses and encode the angular velocity of the rotor 32 into a pulse train signal, which is sent to a drive system 70. Connected to both sensors 46a, 46b, the drive system 70 may include at least one processor, processing circuit, controller, control unit, or other electrical component. The drive system 70 processes the pulse train signals from sensors 46a, 46b and determines the corrected angular velocity of the rotor 32 based on those signals. In an alternate embodiment of the present invention, at least one of the sensors 46a, 46b may have a processor to process the detected inputs to determine the angular velocity of the rotor 32. The term angular velocity is used throughout this disclosure for simplicity, however, rotational speed or another similar measure may also be used without departing from the scope of the invention.

According to an exemplary embodiment of the invention, sensors 46a, 46b may be positioned one hundred and eighty (180) encoder wheel degrees apart from each other in order to correct for any eccentricity of the encoder 36. Several conditions can cause encoder eccentricity. For example, if the encoder wheel 38 is not perfectly centered on the rotor 32, eccentricity of some degree will occur. Additionally, if the rotor bearings are out of true or misaligned, the rotor 32 will not be centered on its rotational axis; this can also cause eccentricity. Another cause of eccentricity may be that the reflective disc is attached off-center of the encoder wheel 38. During eccentric rotation of the rotor 32, sensors 46a, 46b will detect that the rotor 32 is moving at two different velocities due to the physical layout of sensors 46a, 46b. More specifically, at any given time sensor 46a will detect the rotor 32 rotating at a first velocity, while sensor 46b will simultaneously detect the rotor 32 rotating at a second velocity for the reasons detailed below. If sensors 46a, 46b are positioned one hundred eighty (180) encoder wheel degrees apart, as shown in the exemplary embodiment of the invention depicted in FIGS. 4A and 5A, averaging the first velocity and the second velocity will result in a corrected velocity of the rotor 32. This corrected velocity is a more accurate evaluation of the elevator motor's velocity.

FIG. 4A depicts an exemplary system in which an encoder wheel 38 is not centered on the rotor 32. The figure depicts the encoder wheel 38 to the right of the center 50 of the rotor 32. If the rotor 32 were to be rotated 180 degrees, the encoder wheel 38 would then be shown to the left of the center 50 as in FIG. 5A. While the encoder wheel 38 is in this position, sensors 46a, 46b are not symmetrically aligned over the circumferential track 40 of the encoder wheel 38 due to the encoder's eccentricity. Referring back to FIG. 4A, sensor 46a detects a lower velocity of the rotor 32 because of this eccentricity. As shown in FIG. 4B, stationary sensor 46a will detect that the reflective strips 44 of the code wheel pattern 42 are spaced farther apart than they actually are because the circumferential track 40 and the encoder wheel 38 are shifted to the right relative to the rotor center 50. Therefore, based on the input from sensor 46a, the drive system 70 will determine a first velocity output which is an underestimation of the actual velocity of the rotor 32.

At the same time sensor 46a detects the first velocity output, sensor 46b detects the second velocity output. As shown in FIG. 4C, stationary sensor 46b will detect that the reflective strips 44 are closer together than they actually are due to the misalignment of the code wheel pattern 42. Sensor 46b will therefore detect that the rotor 32 is rotating faster than it actually is. Therefore, based on the input from sensor 46b, the drive system 70 will determine a second velocity output that is an overestimation of the actual velocity of the rotor 32. By positioning sensors 46a and 46b one hundred eighty (180) encoder wheel degrees out of phase with each other, the first and second velocity output errors resulting from the eccentric rotor rotation for each of sensors 46a and 46b are about equal in magnitude but different in sign. Thus, the average of the first and second velocity outputs will result in a corrected and more accurate measurement of the rotor's 32 actual velocity. Averaging the underestimated velocity output of the first sensor 46a with the overestimated velocity output of the second sensor 46b thereby corrects for the eccentricity of the encoder 36.

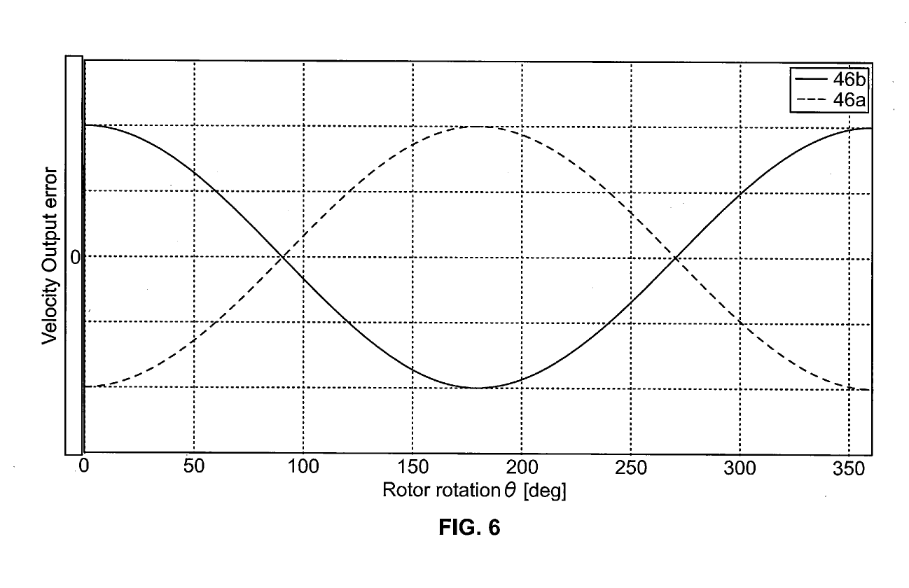

As an example, the graph shown in FIG. 6 plots the waveforms of the first and second rotor velocity output errors, due to encoder eccentricity, of sensors 46a and 46b over the rotor rotation angle θ (in FIG. 4A) throughout one complete rotation of the rotor, or three hundred and sixty (360) degrees. As shown, because sensors 46a and 46b are one hundred eighty (180) encoder wheel degrees out of phase and their respective first and second velocity output errors are about equal in magnitude but opposite in sign, averaging the first and second velocity output errors from sensors 46a and 46b results in the velocity output error being near zero. Thus, the velocity output errors due to the encoder's eccentricity are corrected for and an accurate measurement of the actual velocity of the rotor 32 is obtained.

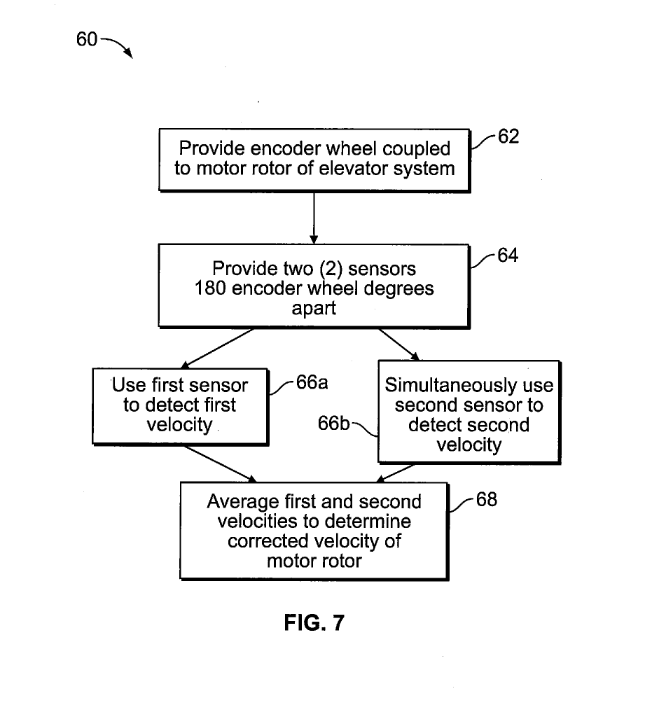

The flowchart of FIG. 7 illustrates a method 60 for correcting for encoder eccentricity in an elevator system 10 according to an exemplary embodiment of the invention. At step 62, the elevator system 10 is provided with an encoder wheel 38 axially coupled to the rotor 32 of the elevator system's motor 26. Next, at step 64, the elevator system 10 is provided with two sensors 46a, 46b mounted to the stator 34 of the elevator system's motor 26. The two sensors 46a, 46b are positioned one hundred eighty (180) encoder wheel degrees apart and are disposed about the circumferential track 40 of the encoder wheel 38 such that sensors 46a, 46b can detect the reflective strips 44 of the code wheel pattern 42. Simultaneously at steps 66a and 66b, the first sensor 46a is used to measure the angular velocity of the encoder wheel 38 and determine a first velocity output of the encoder wheel 38, while the second sensor 46b is used to also measure the angular velocity of the encoder wheel 38 at the same time as the first sensor 46a and determine a second velocity output of the encoder wheel 38. While according to various embodiments of the invention, the sensors 46a, 46b may measure the angular velocity and output a determined velocity, according to other embodiments of the invention the sensors 46a, 46b may only detect certain inputs (such as the presence or absence of a reflective strip) while a processor (either internal to or external from the sensors 46a, 46b) measures the angular velocity and/or determines a velocity output. At step 68, the first velocity determined based on information from the first sensor 46a is averaged with the second velocity determined based on information from the second sensor 46b in order to determine a corrected velocity of the motor rotor 32. By averaging the two velocities based on information from the two sensors 46a, 46b positioned 180 encoder wheel degrees out of phase with each other, an accurate measurement of the motor's actual velocity is obtained by accounting for the eccentricity of the encoder 36.

While the determining of instantaneous rotor velocity at only two positions is described above, the disclosed elevator encoder system and method are capable of correcting for encoder eccentricity and determining accurate instantaneous rotor velocity in elevator systems irrelevant of the specific rotor position. Additionally, sensors 46a and 46b may be disposed in any position about the circumference of the encoder wheel 38, as long as sensors 46a, 46b are spaced approximately one hundred eighty (180) encoder wheel degrees apart from each other and such that sensors 46a, 46b can detect the code wheel pattern 42 on the circumferential track 40 of the encoder wheel 38. The system and method of correcting for encoder eccentricity described herein may be used with any type of rotary encoder for an elevator system without departing from the spirit and scope of the disclosure.

Alternatively, various embodiments according to the invention may utilize sensors that are not positioned approximately one hundred eighty (180) encoder wheel degrees apart as long as the difference in position is known and the determined rotor velocities are weighted to account for the positioning of the sensors. Further embodiments of the invention may use more than two sensors located at different angular positions relative to the rotor as long as the velocities based on the sensor outputs are weighted according to their relative positions.

The system and method of correcting for encoder eccentricity disclosed herein may be used in a wide range of industrial or commercial applications, such as in elevator systems. By using the system and method disclosed herein of correcting for encoder eccentricity in elevator systems, non-linear errors in rotor position and velocity are reduced. Therefore, the drive motor angular position and velocity can be accurately detected, thereby ensuring excellent ride quality in the elevator system.

Furthermore, the system and method described herein is an inexpensive way to correct for eccentricity of the encoder. Only one more encoder component, or sensor, is required for this system and method. Thus, compared to the conventional solution of correcting for encoder eccentricity that requires many added components, such as hollow shaft encoders, precision bearings, and flexible mounting, the cost of correcting for encoder eccentricity described herein is minimal.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments of the invention, these features are not limited to use with only the embodiment with which they are described, but instead may be used together with or separate from, other features disclosed in conjunction with alternate embodiments of the invention.

1. An encoder assembly comprising:
a motor having a rotor; and
an encoder, the encoder comprising:
an encoder wheel axially coupled to the rotor;
a first sensor configured to detect a first velocity at which a portion of the encoder wheel moves relative to the first sensor; and
a second sensor configured to detect a second velocity at which a portion of the encoder wheel moves relative to the second sensor,
the first sensor and the second sensor positioned approximately 180 degrees apart from each other about an axis of rotation of the rotor.

2. The encoder assembly of claim 1, wherein the encoder wheel comprises a code wheel pattern on a circumferential track.

3. The encoder assembly of claim 2, wherein the first and second sensors are configured to detect the code wheel pattern on the circumferential track.

4. The encoder assembly of claim 3, wherein the motor comprises a stator, and wherein the first and second sensors are operatively mounted to the stator and disposed about the circumferential track of the encoder wheel.

5. The encoder assembly of claim 1, wherein the encoder is a reflective optical encoder mounted to the motor.

6. The encoder assembly of claim 1, wherein the encoder assembly is configured to determine an angular velocity of the motor based on the first and second velocities at a point in time.

7. The encoder assembly of claim 1, further comprising a processor, operatively connected to the first and second sensors, the processor configured to determine a rotational speed of the rotor based on inputs from the first sensor and the second sensor.

8. The encoder assembly of claim 7, wherein the processor is part of a drive system.

9. The encoder assembly of claim 8, wherein the drive system determines a corrected velocity of the motor by averaging the first velocity and the second velocity.

10. The encoder assembly of claim 1, wherein the encoder system is a component of an elevator system.

11. A method of correcting for eccentricity of an encoder in an elevator system, comprising:
using a first sensor to detect a first velocity at which a portion of an encoder wheel moves relative to the first sensor, the encoder wheel being axially coupled to a motor rotor of an elevator system;
using a second sensor to simultaneously detect a second velocity at which a portion of the encoder wheel moves relative to the second sensor, the second sensor positioned approximately 180 encoder wheel degrees apart from the first sensor; and
averaging the first velocity and the second velocity to determine a corrected rotational velocity of the motor rotor.

12. The method of claim 11, further comprising using a drive system to determine the first and second velocities based on the input of the first and second sensors, the drive system comprising at least one of a processor, processing circuit, controller, control unit, or other electrical component.

13. The method of claim 11, wherein the first and second sensors detect a code wheel pattern on a circumferential track of the encoder wheel.

14. The method of claim 11, wherein the encoder wheel, first sensor, and second sensor comprise a reflective optical encoder.

15. A system, comprising:
a motor comprising a rotor; and
an encoder, to determine a rotational speed of the rotor, the encoder comprising:
an encoder wheel, axially coupled to the rotor;
a plurality of sensors, fixed at predetermined positions relative to the encoder wheel, each of the plurality of sensors configured to determine a speed at which the encoder wheel passes by the sensor; and
a processor to receive inputs from the plurality of sensors related to the determined speeds, the processor configured to determine an actual speed of rotation of the motor based on the received inputs.

16. The system of claim 15, wherein the plurality of sensors consists of two sensors, and the fixed predetermined positions relative to the encoder are approximately one hundred and eighty degrees apart relative to an axis of rotation of the rotor.

17. The system of claim 15, wherein the processor is configured to determine the actual speed of rotation of the motor by averaging the determined speeds.

18. The system of claim 15, wherein the processor is configured to determine the actual speed of rotation of the motor by averaging the determined speeds according to a weighted average determined by the relative predetermined positions of the plurality of sensors.
